(19) United States
(12) Patent Application Publication
(10) Pub. No.: US 2008/0263325 A1
(43) Pub. Date: Oct. 23, 2008

(54) SYSTEM AND STRUCTURE FOR SYNCHRONIZED THREAD PRIORITY SELECTION IN A DEEPLY PIPELINED MULTITHREADED MICROPROCESSOR

(75) Inventors: Prabhakar Kudva, New York, NY (US); David S. Levitan, Austin, TX (US); Balaram Sinharoy, Poughkeepsie, NY (US); John D. Wellman, Hopewell Junction, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/737,491

(22) Filed: Apr. 19, 2007

(51) Int. Cl. G06F 9/30

(52) U.S. Cl. 712/203

(57) ABSTRACT

A microprocessor and system with improved performance and power in simultaneous multithreading (SMT) microprocessor architecture. The microprocessor and system includes a process wherein the processor has the ability to select instructions from one thread or another in any given processor clock cycle. Instructions from each, thread may be assigned selection priorities at multiple decision points in a processor in a given cycle dynamically. The thread priority is based on monitoring performance behavior and activities in the processor. In the exemplary embodiment, the present invention discloses a microprocessor and system for synchronizing thread priorities among multiple decision points throughout the micro-architecture of the microprocessor. This system and method for synchronizing thread priorities allows each thread priority to he in sync and aware of the status of other thread priorities at various decision points within the microprocessor.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### TECHNICAL FIELD

The embodiments herein relate generally to simultaneous multithreading (SMT) micro-architecture in a microprocessor. Specifically, the embodiments disclose herein describe a method of maximizing performance of a microprocessor by synchronizing the prioritization of instruction processing.

### BACKGROUND

In a SMT micro-architecture, multiple threads make progress through the processor at any given time. When a thread is unable to make progress through the pipeline due to various events such as cache misses, mispredicts and flushes, the other a wading threads utilize this execution vacancy and other units of the processor. Allowing other threads to execute through the pipeline effectively improves the overall throughput of the processor.

The role of thread priority has traditionally been seen as a method to improve performance. The performance goal usually is to maximize the simultaneous multithreaded instructions that complete per cycle in the processor while the power goal is to select instructions in a manner that is most power efficient. With changing technological considerations, it is increasingly important to improve not just performance but a metric that combines both performance and power. While SMT lends itself well to such an optimization (i.e., improvement in performance per watt) the benefits can be lost if the instructions are not carefully selected. For example, if a particular thread is speculating excessively and using up valuable bandwidth through the pipeline thus disabling other threads from making progress, then the benefits of SMT may be lost. Similarly, if a thread has a big cache miss rate and is also using up significant amount of resources in the queues, then the benefits may be lost as well.

In order to maximize the performance, it is important to maximize the instructions in the pipeline that have potential to complete as soon as possible and minimize instructions that tend to stall and use up resources in the pipeline that could be used by other threads.

In order to minimize power consumed, the goal is to reduce the average pipeline stage occupancy rate of each instruction to the number of instructions completed. Given this metric, cache misses tend to decrease this metric. Similarly, excessive speculation resulting in flushes also decreases this metric. A careful selection of instructions that have a higher potential to complete can improve this metric. Such a selection and control mechanism can be provided by thread priority.

Typically, in some a short pipeline processors, a stage is added to the traditional live-stage pipeline immediately after the fetch stage. This stage is called thread priority stage. The thread priority stage acts as an arbitrator to decide which of the instructions from the different threads that are currently active in the fetch stage should enter the back-end pipe beginning with the decode stage. The thread priority stage monitors a variety of factors including cache behaviors (hits/misses), branch behaviors, queue occupancies and other performance and power parameters of the design. The thread priority can have high predictive accuracy due to the shorter length of the pipeline. The fixed number of stages and the in-order flow provides information of the status of each stage and helps in choosing the next instruction to enter the pipeline. Short pipelines are not used for optimizing single-thread performance. Instead the focus is on maximizing system throughput in a thread-rich environment. The separation of these goals (single-thread performance versus Multi-threaded performance) enables this approach.

In a deeper pipeline, which has a goal of improving both single-thread performance as well as multi-threaded performance, the thread priority algorithm and mechanisms are different. Deeper pipelines tend to be more elastic having significant amount of buffering between stages. This elasticity reduces the effect one may have due to priority. A good example occurs with fetch priority. If instruction buffers are sufficiently deep, then the benefits of having a per cycle priority at the fetch stage may be reduced, further. In out-of-order machines, it is harder to predict the instructions that make forward progress through the pipelines. Other factors such as speculation, rejects and hushes decrease the predictive quality of the pipeline. The fetch priorities in previous processors are modified statically based on various register settings (user and operating system modifiable) as well as dynamically based on the occupancies of the instruction buffers corresponding to each thread. The prior art methods fail to teach synchronized multi-thread priority stages.

### SUMMARY

In an exemplary embodiment, disclosed herein is a system for synchronizing thread priorities in a simultaneous multithreading microprocessor. The system comprises a plurality of pipelines including a number of stages, each stage processing one or more instructions, the instructions belonging to a plurality of threads. The system also comprises a plurality of buffers storing a plurality of instructions and located between adjacent stages in the pipelines, the stored instructions being from different ones of the plurality of threads. A plurality of thread priority selection blocks that select instructions from the plurality of threads at various decision points in the pipelines is also used. A communication mechanism between the thread priority selection blocks is used to synchronize the instruction selection performed by the thread priority selection blocks from the instructions belonging to the plurality of threads at different stages of the pipelines. The thread priority selection blocks choose instructions from the plurality of threads and gives highest priority to instructions that are most likely to improve the overall performance or power of the processor. Each thread priority selection block receives signals from other thread priority selection blocks that indicate the actions performed by those selection blocks.

In an exemplary embodiment, disclosed herein is a multi-threading microprocessor. The microprocessor comprises a plurality of pipelines including a number of stages, each stage processing one or more instructions, the instructions belonging to a plurality of threads. The microprocessor also comprises a plurality of buffers storing a plurality of instructions and located between adjacent stages in the pipelines, the stored instructions being from different ones of the plurality of threads. A plurality of thread priority selection blocks that select instructions from the plurality of threads at various decision points in the pipelines is also used, wherein the thread priority selection blocks are implemented as hardware with inputs received from power and performance monitors within the processor as well as other thread priority selectors and provides outputs to select instructions from the plurality of threads. A communication mechanism between the thread priority selection blocks is used to synchronize the instruction selection performed by the thread priority selection blocks from the instructions belonging to the plurality of threads at different stages of the pipelines. The thread priority selection blocks chooses instructions from the plurality of threads and gives highest priority to instructions that are most likely to improve the overall performance or power of the processor. Bach thread priority selection block receives signals irons other thread priority selection blocks that indicate the actions performed by those selection blocks.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

The embodiments disclosed herein describe a system and method to improve performance in simultaneous multithreading (SMT) microprocessor architecture, in an exemplary embodiment, a process wherein the processor has the ability to select instructions from one thread or another in arty given processor clock cycle is provided. each thread may be assigned a selection priority in a given cycle dynamically. The thread priority is based on monitoring power performance behavior and activities in the processor. In an exemplary embodiment, a system and method for synchronizing thread priorities among multiple decision points throughout the micro-architecture of the microprocessor is provided. This system and method for synchronizing thread priorities allows each tread priority to be in sync and aware of the status of oilier thread priorities at various decision points in the microprocessor.

### BRIEF DESCRIPTION OF THE DRAWINGS

The subject matter, which is regarded as an exemplary embodiment of the invention, is particularly pointed out and distinctly claimed in the claims at the conclusion of the specification. The foregoing and other objects, features, and advantages of the exemplary embodiment of the invention are apparent from the following detailed description taken in conjunction with the accompanying drawings in which:

FIG. 1 illustrates the synchronization between thread priority selection blocks at various stages in the pipeline in an exemplary embodiment.

FIG. 2A illustrates a decode priority implementation of each thread in accordance with an exemplary embodiment.

FIG. 2B illustrates an exemplary embodiment of a shift register used to track events in the processor.

FIG. 3 illustrates a table of the fetch priority in accordance with an exemplary embodiment.

FIG. 4 illustrates a flow chart of the thread priority behavior in a given cycle in accordance with an exemplary embodiment.

The detailed description explains the preferred embodiments of the invention, together with advantages arid features, by way of example with reference to the drawings.

### DETAILED DESCRIPTION

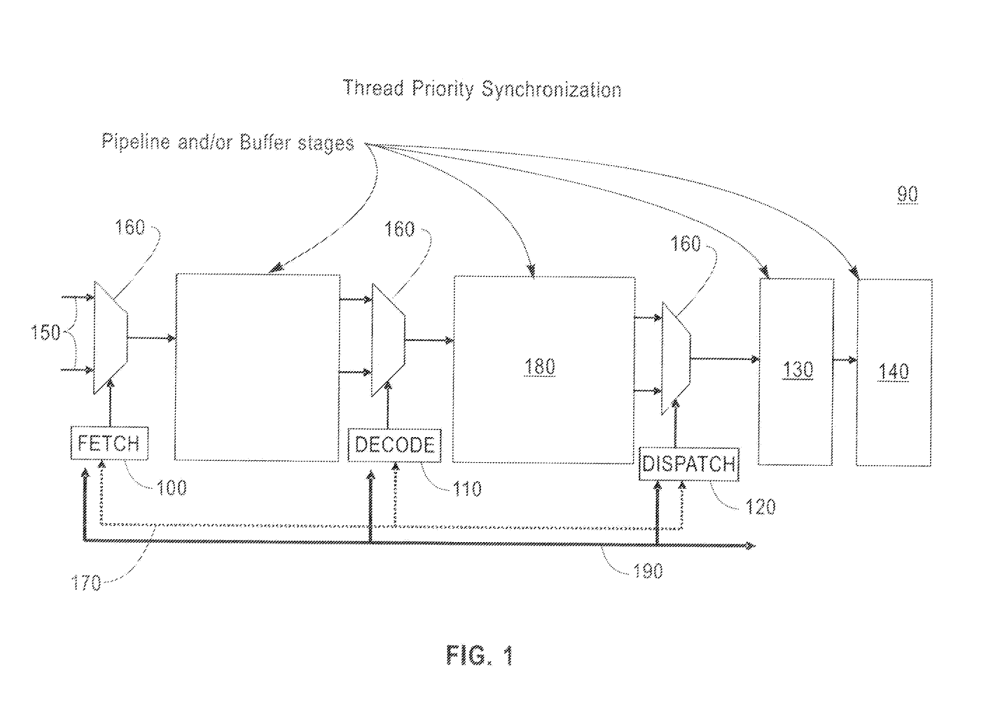

FIG. 1 is an exemplary embodiment showing a conceptual illustration of each of the thread priority selection blocks, 100, 110, and 120. The components include an instruction selector 160 along with a priority logic (i.e., priority selection blocks 100, 110, and 120), which has as input signals 150, and including, power and performance events from the microprocessor 190 as well as the status of other thread priority selectors 170. The status of the other thread priority selectors is communicated between the different thread priority selection blocks through communication means 170.

Exemplary embodiments described herein include an SMT processor having multiple priority selections at various “decision points” 100, 110, 120, and 160 that exist in a deep superscalar pipeline. Referring to FIG. 1, for example, one decision point, selects which of the instruction fetch address registers (IFARs) 100 to fetch during a given cycle (before the instruction butlers). A second decision point is the decode point 110 when multiple instruction buffers merge into a single pipeline beginning wife, decode. A thud decision point in an exemplary embodiment exists at dispatch 120 (before the issue queue buffers 130;, which select the instructions that enter the issue queue 130. If the various decision points are not synchronized with each other, the benefit from thread priority to the processor performance and power is reduced.

In an exemplary embodiment, the system and apparatus described herein synchronize these different priorities. For example, the fetch priority 100 is synchronized with the decode priority 110. If the decode priority 110 is transferring a large number of instructions stored in an instruction buffer of a given thread to the decode stage 110, then it is important that the fetch stage 100 is able to fill the instruction buffer at that rate as seed.

For example, alter a Level 2 (L2) cache miss for a given thread, instructions are stopped for that thread at both the fetch priority 100 and decode priority 110 decision points. The thread progress is put to sleep for a given number of cycles. Therefore, the fetch priority 100 for that thread is designed to wake up earlier than the decode priority 110 for the same thread.

If a dispatch priority 120 is transferring more instructions to the issue queue 130 for a given thread, the decode priority 110 provides an equal rate of instructions for that thread as well. If there is a mismatch and the decode-to-dispatch queue 180 is filled with instructions from threads that are not able to make progress, then the performance is severely affected.

In accordance with an exemplary embodiment, the systems and methods described herein further synchronize thread priorities when the issue queue 130 is filling up with instructions that are blocked with synchronization threads from other instructions, which are ready for execution. These blocked threads are not able to enter the issue queue 130 and are therefore penalized. The issue queue 130 can fill up if the dispatch priority 120 is not synchronized with the behavior of the load-store queues 140 and the cache behaviors of the thread.

The above examples serve to illustrate the importance of synchronization between the various priorities. These examples also illustrate how situations arise wherein various portions of the pipeline are blocked by threads that are not making progress thereby wasting resources and blocking other threads. This problem can occur even in the ease of multiple thread priorities at various points in the pipeline. This occurs due to a lime lag between the priorities. For example by the time, the dispatch stage 110 realizes that a particular thread is not able to issue very well, instructions may have already entered the decode/dispatch queue 180 from the instruction butlers and end up using up the decode/dispatch 180 resources. Such situations may warrant a “flush” of the pipeline, winch may impact performance and power negatively.

The above discussions highlight that a complete SMT thread priority system should include carefully balanced algorithms that involve the following: monitoring of selected parameters in the design, prioritizing at multiple priority points, synchronizing between these priorities, and minimizing carefully the use of flushes and selection of the correct flush (dispatch/issue/load-store etc) based on a situation.

Instructions sitting in the pipeline that are not making progress not only block other instructions, but also consume power, in general the following aspects are considered for minimizing power consumption (i.e., stage utilization/completing instructions): showing preference for threads that issue/complete at a luster rate, lowering preference for excessive speculation, reducing the number of instructions “sitting” in the pipelines and managing or minimizing the number of flushes.

Each, thread has its own instruction buffer and the pipeline may be partitioned into two or more where each partition processes a pair of logical threads, in addition, each thread may have its own global completion table that independently monitors the number of live instructions for a thread.

Efficient methods to monitor key events are required that give a clear picture of the behavior of the machine on a cycle-by-cycle basis. Counters tend to be problematic since they start from an initial value 0 and then count up either saturating or starting over. The following example illustrates a problem with the use of counters. Consider a counter that was initiated at time n. if the machine at time n+20, would like to have information as to how many events of a particular type occurred over the last eighty cycles, the counter cannot provide this form of information. The counter creates points of discontinuity in the monitored count since it has to initialize to zero every so often.

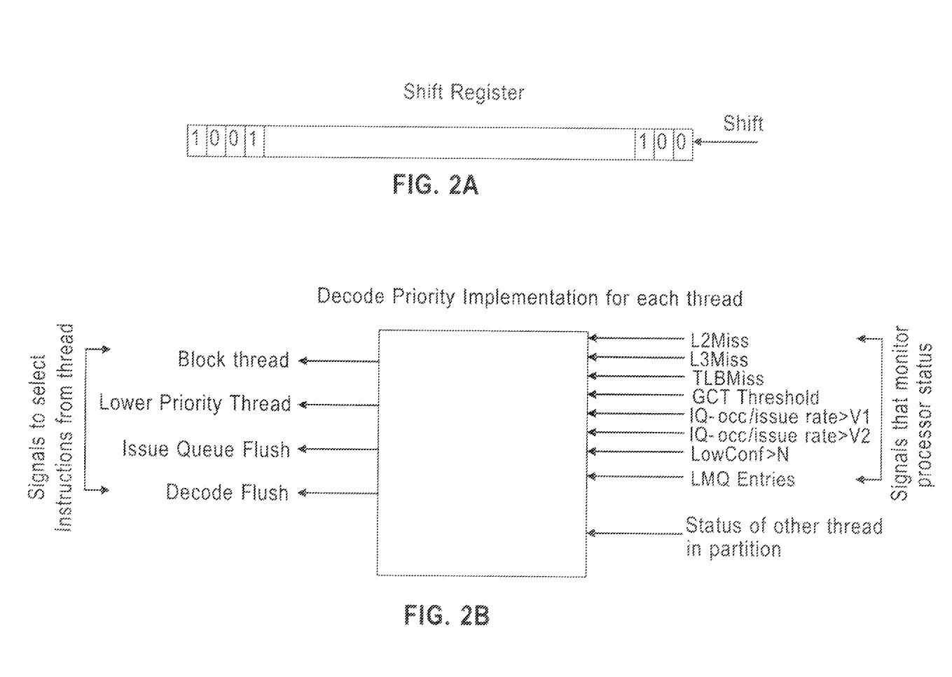

In an exemplary embodiment, a shift register approach of tracking events can be implemented. A shift register (e.g., size 64 bits) is maintained for each event, as shown in FIG. 2A. livery cycle, the register is shifted left with a leading 0 or 1 introduced into the LSB. A 0 is introduced when the event (L2 miss) does not occur and a 1 is introduced when the event (L2 miss) occurs. The shift register therefore keeps a record of the event behavior over the last 64 bits. Such a register not only provides the number of events occurring over a given period of time, but also provides information of the nature of the behavior (clustering of events, patterns of behavior).

A way to calculate the number of L2 miss events within the last 64 cycles is to count the number of is in the shift registers. A fast adder followed by a comparator to (XORs) zero is sufficient for this purpose. The number of 1.2 miss events within the last any n cycles <64 can similarly be calculated. Other clustering/pattern detection circuits may be added although the area complexity of such additional hardware requires careful thought.

In an exemplary embodiment, the baseline priority is “round robin” to prevent starvation of any one thread, as shown in FIG. 2A. A “round robin” is an arrangement of choosing all elements in a group equally in some rational order, usually from the front to the back of a hue and then starting again at the next element at the top of the line and so on, in atypical decode selection or example, instruction buffers are checked in round robin order and the instructions from the first instruction buffer able to send a group is selected to be sent into the decode stage.

As illustrated in FIG. 28, the priority logic may have multiple outputs. These include output signals to block the thread and output signals to change relative priority. These two forms of priorities are explained in greater detail below.

In the first scheme, a thread may be blocked (as in the case of a L2 miss) for several cycles even when it the current stage has instructions available to send to the next stage for the thread and other threads do not have any instructions to send. These cases occur on relatively rare events.

In the second case, the priority order of threads from which instructions are desired to be transferred to the next stage is selected. Priority only modifies this base order.

As an illustration of the concept of base order in the second ease, consider that in Cycle 0, the order is 0123 and no priorities occur. In Cycle 1, base order 1230 is considered, but it is observed that thread 3 has a very high priority and therefore the base order is modified to 3120. Similarly, in Cycle 3, the base order for priority now becomes 2301. If thread 3 still has priority, then the priority order is modified from the base order to 3201. In Cycle 4, the base order becomes 3012 and if the priority now indicates thread 2 to be the highest, the priority order is now 2301 and so on.

In a logically partitioned architecture where multiple threads are assigned to each partition from decode onwards (including dispatch/execution/issue), the priority order is selected within a partition.

The decode priority is an important point of priority enforcement since this is the point where multiple pipes of fetched instructions merge into a single decode pipe. It is important at this point that instructions are carefully selected from among the ones resident in the various threads. Since the bandwidth of the decode pipe and the dispatch pipes that follow it are narrower than the cumulative bandwidth of the instruction buffers, if is important that the instructions most likely to complete are selected at this point.

In an exemplary embodiment, determining the priority of threads from which to progress instructions to the next stage from fetch to decode may be based on the following exemplary parameters that are monitored and response events generated in addition to the information about the status of the dispatch priority.
Event 1: LEVEL 2 Miss vector=x00001∥LEVEL 3 Miss vector=0x00001∥TLB Miss
Response 1: Issue Queue Flush, start L2/L3/TLB Miss timer
Even 2: LEVEL 2 Miss vector>0∥LEVEL 3 Miss vector>0∥TLB Miss
Response 2: Block thread at decode for L2/L3/TLB Miss Timer—delay cycles to allow the instructions to reach the cache at the time of refill of the line.
Event 3: GCT for thread occupancy>VAL
Response 3: Block thread at decode until LSB of event monitor=0
Event 4: Issue Queue Occupancy by thread/Issue rate of thread>VALUE1
Response 4: Block thread at decode until value of event monitor=0
Event 5: # of low confidence branches in pipe>VALUE
Response 5: Block thread at decode until value of event monitor=0
Event 6: Issue Queue Occupancy by thread/Issue rate of thread<VALUE2
Response 6: Flush issue queue for that thread VALUB2>>VALUE1
Event 7: Many Long Latency Functional Operations in Decode/issue Queue
Response 7: Reduce Decode Priority for thread for n cycles (latencies of operation)
   These parameters are explained in greater detail below.

Events 1 and 2, take precedence and are the ones for which the response is exercised immediately. Event 3, limits the number of instructions from any given thread. Event 3 can occur even in the absence of events 1 and 2, when there are long latency Instructions for a given thread in the case of large number of Level 1 and Level 15 misses or when there are a large number of long latency operations and the thread is not making sufficient progress. Event 4 can occur for the same reasons as event 3, but indicates that the issue queues are blocked. Event 5 reduces the amount or instructions in the pipe from a speculated thread and is especially helpful for power saving. Event 6 indicates a blocked issue queue. The overall response may be viewed as a Boolean OR of all responses.

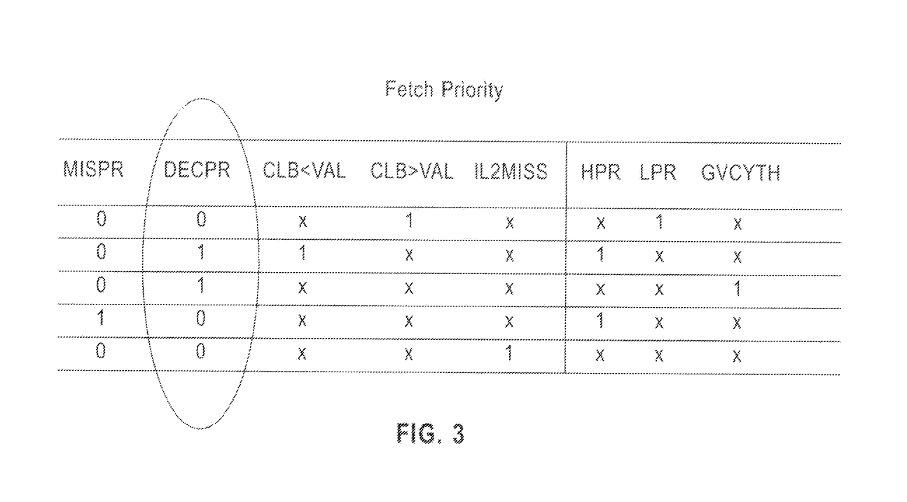

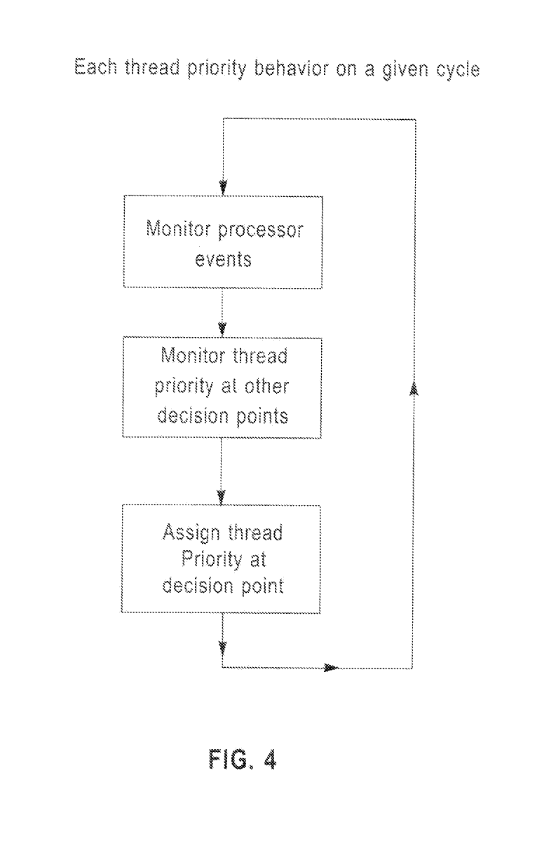

As shown in FIG. 3, the fetch priority tracks the decode priority (DECPR) with a time lag. This illustrates the synchronization between fetch and decode priorities. However, at times the fetch priority may need to be ahead in time with respect to the decode priority. An example of this is as follows. Consider Response 2 of the decode priority, due to a L2 miss, the instruction buffer for that thread is empty. The instruction buffer needs to be filled up at least a few cycles before the decode priority for that thread is enabled.

In addition to tracking the decode priority, the fetch priority also addresses the following event and responses:
Event 1: Flush of a thread due to mispredict
Response 1: Raise fetch priority for that thread
Event 2: Large number of low confidence branches in the instruction buffer
Response 2: Lower fetch priority for that thread
Event 3: instruction buffer Occupancy>VALUE
Response 3: Lower fetch priority for that thread
Event 4: Instruction buffer Occupancy<VALUE && Decode priority high for thread
Response 4: Increase fetch priority for that thread
Event 2: LEVEL 2 Miss vector>0∥LEVEL 3 Miss vector>0
Response 2: Block thread at decode for LEVEL 2/LEVEL 3 Miss Timer—N cycles to allow the instructions to fill up the instruction, butters before decode priority changes

The dispatch priority limits the threads ability to move into the issue queue, which prevents the issue queue from being blocked.

The dispatch priority has low priority for thread if miss rates for each thread (load/store real location) are forced to low priority. The dispatch priority is also low if the issue queue occupancy is high for the thread whether due to instruction dependency or load/store behavior. Further, there is a low priority for thread dispatch if there are s large number of rejects from a thread for any reason. This priority is synchronized to the decode priority as well. The dispatch priority also considers the load/store unit as well as the load miss queues (LMQs):
Event 1: Long latency instruction entered issue queue
Response 1: Block dispatch priority for that thread for n cycles,
Event 2: Multiple long latency instructions entered issue queue (included loads)
Response 2: Dispatch Flush for thread
Event 2: Large number of LMQ entries used up by a thread
Response 3: Lower dispatch priority for that thread.

One example of a synchronized thread priority system is shown in the EKE 4. Each thread priority hardware logic block monitors both the events relevant to that priority as outlined in the previous section as well as the priorities set by other selectors further ahead in the pipeline.

The capabilities of the present invention can be implemented in software. firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may he performed in a differing order, or steps may be added, deleted or modified. All of these variations are considered a part of the claimed invention.

While the preferred embodiment to the invention has been described, it is understood that those skilled in the art, both now and in the future, may make various improvements and enhancements which tail within the scope of the claims which follow. These claims should be construed to maintain the proper protection for the invention first described.

What is claimed is:

1. A system for synchronizing thread priorities in a simultaneous multithreading microprocessor, the system comprising:
a plurality of pipelines including a number of stages, each stage processing one or more instructions, the Instructions belonging to a plurality of threads;
a plurality of buffers storing a plurality of instructions and located between adjacent stages in the pipelines, the stored instructions being from different ones of the plurality of threads;
a plurality of thread priority selection blocks that select instructions from the plurality of threads at various decision points in the pipelines, wherein the thread priority selection blocks include a dispatch priority, a fetch priority and a decode priority; and
a communication mechanism between the thread priority selection blocks to synchronize the instruction selection performed by the thread priority selection blocks for instructions belonging to the plurality of threads at different stages of the pipelines, wherein:
a thread priority selection algorithm in each thread priority selection block receives signals from the other thread priority selection blocks, which indicates the actions performed by those selection blocks, and wherein:
the thread priority selection blocks chooses instructions from the plurality of threads and uses the thread priority selection algorithm to give the highest priority to instructions that are most likely to improve the overall performance or power of the processor.

2. The system of claim 1, wherein each thread priority selection block receives signals from power and performance monitors in the microprocessor, which it incorporates into the decision making of the thread priority selection algorithm.

3. The system of claim 2 wherein the fetch priority uses as input, the output status of other thread priority selection blocks and chooses instructions from the plurality of threads and uses the thread priority selection algorithm to give the highest priority to instructions that are most likely to improve the overall performance or power of the processor.

4. The system of claim 3, wherein the decode priority uses as input, an output status of other thread priority selection blocks and chooses instructions from the plurality of threads and uses the thread priority selection algorithm to give highest priority to instructions that are most likely to improve the overall performance or power of the processor.

5. A multi-threaded processor comprising:
a plurality of pipelines including a number of stages, each stage processing one or more instructions, the instructions belonging to a plurality of threads;
a plurality of buffers storing a plurality of instructions and located between adjacent stages in the pipelines, the stored instructions being from different ones of the plurality of threads;
a plurality of thread priority selection blocks that select instructions from the plurality of threads at various decision points in the pipelines, wherein the thread priority selection blocks are implemented as hardware with inputs received from, power and performance monitors within the processor as well as other thread priority selectors and provides outputs to select instructions from the plurality of threads; and
a communication mechanism between the thread priority selection blocks to synchronize the instruction selection performed by the thread priority selection blocks for the instructions belonging to the plurality of threads at different stages of the pipelines, wherein:
an algorithm in each thread priority selection block receives signals from the other thread priority selection blocks, which indicates the actions performed by those selection blocks, and wherein:
the thread priority selection blocks chooses instructions from the plurality of threads and uses the algorithm to give the highest priority to instructions that are most likely to improve the overall performance or power of the processor.
